(19) United States
(12) Patent Application Publication
(10) Pub. No.: US 2026/0145177 A1
(43) Pub. Date: May 28, 2026

(54) MOBILE BULK MATERIAL PROCESSING APPARATUS

(71) Applicant: SANDVIK LTD, Dungannon (GB)

(72) Inventors: Stuart SMYTH, Dungannon (GB); Stuart GRAYDON, Dungannon (GB)

(21) Appl. No.: 19/121,926

(22) PCT Filed: Oct. 17, 2023
(86) PCT No.: PCT/EP2023/078798

§ 371 Date: Apr. 17, 2025

(30) Foreign Application Priority Data
Oct. 18, 2022 (EP) 22202096.8

(51) Int. Cl. B02C 23/02; B02C 21/02

(52) U.S. Cl. CPC B02C 23/02; B02C 21/026

(57) ABSTRACT

A mobile bulk material processing apparatus includes a bulk material primary processing unit detachably attached to a main frame and includes a bulk material inlet, and a feedstation to feed bulk material to the primary processing unit. The feedstation includes a feedstation frame and a bulk material feeder. The bulk material feeder has a rearward feed end to receive bulk material and a frontward discharge end that overlaps the bulk material inlet. A rearward end of the feedstation frame is connected to the main frame for pivotable actuation in an arc from an operating position in which the discharge end of the bulk material feeder overlaps the bulk material inlet to a non-operating position in which the discharge end of the bulk material feeder is disposed rearwardly of the bulk material inlet to allow the primary processing unit to be vertically lifted away from the main frame.

### FIELD OF THE INVENTION

The present invention relates to a mobile bulk material processing apparatus comprising a bulk material feed station and a primary processing unit for the bulk material. In particular, the invention relates to a mobile bulk material processing apparatus having a bulk material crusher. The invention also relates to a method of detaching a primary processing unit from a mobile bulk material processing apparatus.

### BACKGROUND TO THE INVENTION

Mobile bulk material processing apparatus are shipped all over the world. As the transport laws regarding dimensions and weights are different to each specific region, these differences can make selling a product difficult if it becomes logistically problematic to deliver. There are unique ways to reduce the overall weight of the product down, one of these is by removing the primary processing unit (e.g., the crushing chamber) and shipping it separately, which normally accounts for a large amount of total weight. However, due to the nature of bulk processing apparatus the feed discharge chute must overlap the crushing chamber inlet chute to ensure no spillage occurs during operation. With this overlap present it becomes difficult to remove the crushing chamber quickly and efficiently, as other items on the product must be removed first.

It is an objective of the invention to overcome at least one of the above-referenced problems.

### SUMMARY OF THE INVENTION

The objective is met by the provision of a mobile bulk material processing apparatus that has a feedstation frame mounted to the main frame for pivotable movement of the feedstation frame in an arc from an operating position in which a discharge end of the bulk material feeder overlaps a bulk material inlet of the primary processing unit to a non-operating position in which the discharge end of the feeder is disposed rearwardly and upwardly of the inlet of the primary processing unit. Pivotal attachment of the feedstation frame to the main frame provides an efficient method of distancing the discharge end of the bulk material feeder from the inlet and provides space for the primary processing unit to be detached from the main frame and vertically lifted away from the main frame. A pivoting articulation arrangement also allows the feedstation to be articulated using only a fluidic ram on each side of the frame, without the needs for additional motors and other articulation systems. In addition, it allows difficult to access parts of the apparatus to be accessed, such as the jaw wedge bolts, rubber seals, chute liners and the underscreen mesh.

In a first aspect, the invention provides a mobile bulk material processing apparatus comprising:
a main frame having a front part and a rear part;
a bulk material primary processing unit detachably attached to the front part of the main frame and comprising a bulk material inlet; and
a feedstation to feed bulk material to the primary processing unit, the feedstation comprising a feedstation frame connected to rear part of the main frame and a bulk material feeder connected to the feedstation frame, the bulk material feeder having a rearward feed end to receive bulk material and a frontward discharge end that overlaps the bulk material inlet of the primary processing unit
wherein a rearward end of the feedstation frame is pivotably connected to the rear part of main frame for pivotable actuation of the feedstation frame in an arc from an operating position in which the discharge end of the conveyor overlaps the bulk material inlet of the primary processing unit to a non-operating position in which the in which the discharge end of the conveyor is disposed rearwardly of the crushing chamber inlet to allow the primary processing unit to be vertically lifted away from the main frame.

In any embodiment, the primary processing unit is a bulk material crusher having a crushing chamber.

In any embodiment, the crusher is selected from a jaw crusher, a cone crusher and an impact crusher.

In any embodiment, the mobile bulk material processing apparatus comprises a pivot actuator module mounted between the main frame and the feedstation frame to controllably pivot the feedstation frame in an arc between the operating position and non-operating position.

In any embodiment, the pivot actuator module comprises a fluidic ram (hydraulic or pneumatic) disposed on each side of the apparatus, each fluidic ram being coupled at one end to the main frame and at the other end to the feedstation frame.

In any embodiment, the pivot actuator module is configured to pivot the feedstation frame to a non-operating position that is disposed at an angle e of 10° to 30° to the operating position.

In any embodiment, the feedstation frame is disposed substantially horizontally when in the operating position.

In any embodiment, the apparatus comprises a locking module to lock the feedstation frame in a pivoted non-operating position. Generally, the locking module comprises two locking units, one disposed on each side of the apparatus. In any embodiment, the locking module is configured to lock the feedstation frame in a plurality of non-operating positions.

In any embodiment, the locking module comprises a main frame locking aperture in the main frame, a feedstation frame locking aperture in the feedstation frame positioned to overlap the mainframe locking aperture in the main frame when the feedstation is in a non-operating position, and optionally a locking pin configured to pass through the first and second apertures to lock the feedstation frame in a pivoted position relative to the main frame.

In any embodiment, the main frame comprises a first main frame locking aperture and a second main frame locking aperture disposed above the first main frame locking aperture configured to lock the feedstation frame in two non-operating positions.

In any embodiment, the or each main fame locking aperture is provided on an upstanding locking arm, and wherein the feedstation frame comprises a recess configured to receive the locking upright and comprising the feedstation frame aperture.

In any embodiment, the rearward end of the feedstation frame is pivotably connected to the rear of the main frame by a pivot joint comprising a pivot pin.

In any embodiment, the rearward end of the feedstation frame is pivotably connected to the main frame by a pivot joint comprising a first pivot joint part disposed on the main frame comprising a cylindrical pivot pin housing, a second pivot joint part comprising apertures on the feedstation frame that align with the cylindrical pivot pin housing, and a pivot pin.

In any embodiment, the first pivot joint part disposed on the main frame comprises a pair of spaced apart flange sections supporting the cylindrical pivot pin housing, each having a slanted section that extends forwardly and downwardly away from the pivot pin housing, wherein the second pivot joint part comprises locking apertures disposed forwardly of the cylindrical pivot pin housing to receive a second locking pin when the feedstation is pivoted into the non-operating position.

In another aspect, the invention provides a method of operating a mobile bulk material processing apparatus according to the invention, comprising the step of pivotably actuating the feedstation frame in an arc from the operating position in which the discharge end of the conveyor overlaps the bulk material inlet of the primary processing unit to a non-operating position in which the discharge end of the conveyor is disposed rearwardly and upwardly of the crushing chamber.

In any embodiment, the method comprises uncoupling the primary processing unit from the main frame and lifting the primary processing unit upwardly away from the main frame.

In any embodiment, the method comprises accessing or performing maintenance on or replacing difficult to access parts of the apparatus that are accessible as a result of the pivotable actuation of the feedstation frame into the non-operating position.

In any embodiment, the difficult to access parts are selected from jaw wedge bolts, rubber seals, chute liners and the underscreen mesh.

In any embodiment, the mobile bulk material processing apparatus comprises a pivot actuator module, in which the step of pivotably actuating the feedstation frame in an arc from the operating position to the non-operating position comprises actuation of the pivot actuator module.

In any embodiment, the primary processing unit is a crusher chamber.

In any embodiment, the primary processing unit is a jaw crusher chamber.

Other aspects and preferred embodiments of the invention are defined and described in the other claims set out below.

### BRIEF DESCRIPTION OF THE FIGURES

FIG. 1 is a side elevational view of part of a mobile bulk material processing apparatus according to the invention showing the feedstation and a jaw crusher.

FIG. 2 is a detailed side elevational view of the forward end of the bulk material feeder overlapping the bulk material inlet of the primary processing unit which in this case is a jaw crusher.

FIG. 3 is a plan view from above of the forward end of the bulk material feeder overlapping the bulk material inlet of the jaw crusher.

FIG. 4 is a side elevational view of part of a mobile bulk material processing apparatus of FIG. 1 in a tilted non-operating position.

FIG. 5 is a detailed side elevational view of the forward end of the bulk material feeder and the bulk material inlet of the jaw crusher when the feedstation is in a tilted non-operating position.

FIG. 6 is a plan view from above of the forward end of the bulk material feeder and the bulk material inlet of the jaw crusher when the feedstation is in a tilted non-operating position.

FIG. 7a is a sectional perspective view of the feedstation frame pivoted upwardly in a non-operating position and showing the actuation ram coupled between the main frame and the feedstation frame in an extended position.

FIG. 7b is a sectional perspective view of the feedstation frame in an operating position and prior to pivoting and showing the actuation ram in a retracted position.

FIG. 8a is a side elevation view of the rear of the mainframe showing the locking arm of the locking module and the mainframe pivot mounting.

FIG. 8B is a sectional view of the locking arm showing the two mainframe locking apertures.

FIG. 8c is a perspective partly sectional view showing the feedstation frame in a pivoted non-operating position with the upper mainframe locking apertures aligned with the feedstation frame locking apertures and a locking pin extending through the apertures to lock the feedstation frame in the second non-operating position.

### DETAILED DESCRIPTION OF THE INVENTION

All publications, patents, patent applications and other references mentioned herein are hereby incorporated by reference in their entireties for all purposes as if each individual publication, patent or patent application were specifically and individually indicated to be incorporated by reference and the content thereof recited in full.

Where used herein and unless specifically indicated otherwise, the following terms are intended to have the following meanings in addition to any broader (or narrower) meanings the terms might enjoy in the art:
Unless otherwise required by context, the use herein of the singular is to be read to include the plural and vice versa. The term “a” or “an” used in relation to an entity is to be read to refer to one or more of that entity. As such, the terms “a” (or “an”), “one or more,” and “at least one” are used interchangeably herein.

As used herein, the term “comprise,” or variations thereof such as “comprises” or “comprising,” are to be read to indicate the inclusion of any recited integer (e.g., a feature, element, characteristic, property, method/process step or limitation) or group of integers (e.g., features, element, characteristics, properties, method/process steps or limitations) but not the exclusion of any other integer or group of integers. Thus, as used herein the term “comprising” is inclusive or open-ended and does not exclude additional, unrecited integers or method/process steps.

As used herein, the term “bulk material primary processing unit” primarily refers to a bulk material crusher such as a jaw crusher, cone crusher, or impact crusher, the details of which will be known to a person skilled in the art. However, the term is not intended to be restricted to crushers and may include other bulk material processing units.

As used herein the term “bulk material feeder” refers to a part of the feedstation that conveys bulk material from a feedstation to a bulk material inlet of the primary processing unit (which in most cases will be a crushing inlet of a crusher which feeds into a crushing chamber). The feeder is usually a vibrating feeder. The feeder typically comprises a screen. The feedstation may also include a diverter chute under the feeder to receive material from the feeder and convey it to a specific path.

As used herein, the term “difficult to access parts” of the apparatus of the invention refers to parts of the apparatus that are inaccessible or difficult to access when the apparatus is in an operating position but that are accessible as a result of the feedstation frame being tilted upwardly and rearwardly in an arc to the non-operating position. The parts include, for example, jaw wedge bolts, rubber seals, chute liners and the underscreen mesh.

### Exemplification

The invention will now be described with reference to specific Examples. These are merely exemplary and for illustrative purposes only: they are not intended to be limiting in any way to the scope of the monopoly claimed or to the invention described. These examples constitute the best mode currently contemplated for practicing the invention.

### Equivalents

The foregoing description details presently preferred embodiments of the present invention. Numerous modifications and variations in practice thereof are expected to occur to those skilled in the art upon consideration of these descriptions. Those modifications and variations are intended to be encompassed within the claims appended hereto.

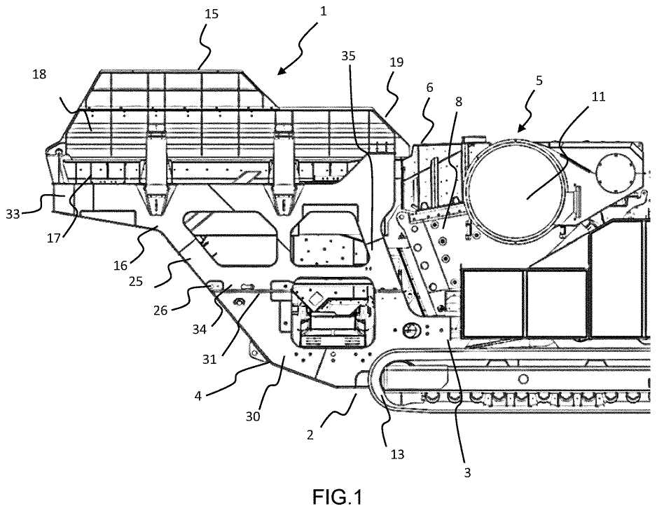

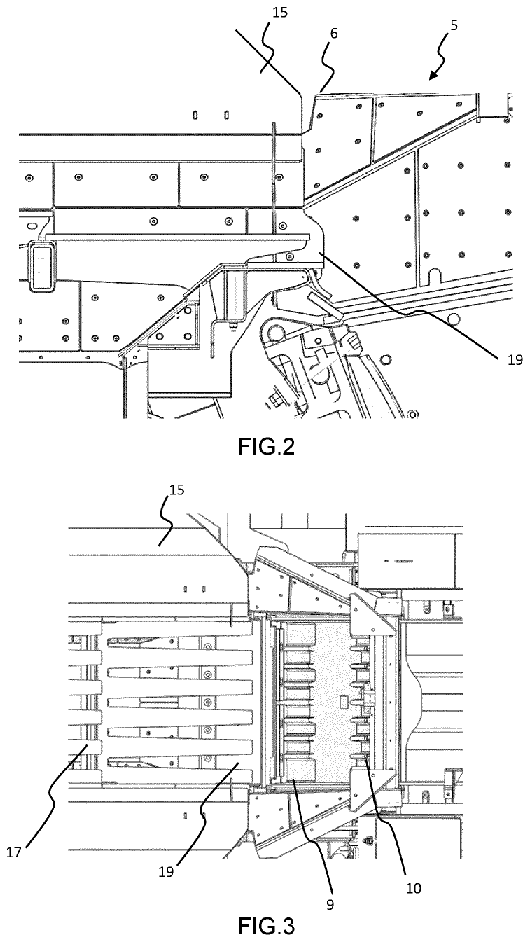

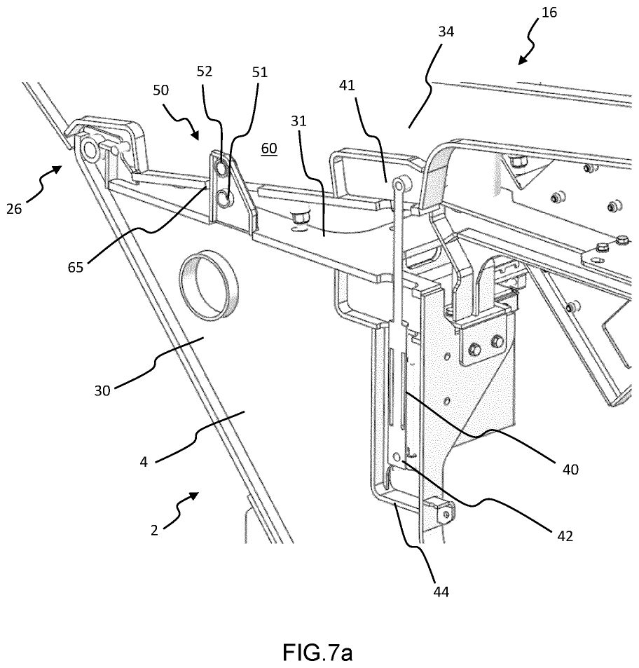

Referring to the drawings and initially to FIGS. 1 to 5, there is illustrated a mobile bulk material processing apparatus according to the invention and indicated generally by the reference numeral 1. The apparatus comprises a main frame 2 having a front part 3 and a rear part 4, and a bulk material primary processing unit 5 detachably attached to the front part of the main frame and comprising a bulk material inlet 6. In the embodiment described, the primary processing unit is a jaw crusher having a crusher housing 8, a fixed jaw 9, a swing jaw 10, and a flywheel 11 attached to a motor (not shown). It will be appreciated that the crusher may also be a cone crusher or an impact crusher. The jaw crusher is a conventional jaw crusher and will not be described in any further detail herein other than to say that it is detachable mounted to the main fame to allow it to be uncoupled from the main frame and removed.

The apparatus 1 also includes tracks 13, once mounted to each side of the main frame and powered by a motor (not shown), that allow the apparatus to be moved.

The apparatus 1 also comprises a bulk material feedstation 15 to feed bulk material to the primary processing unit 5. The feedstation 15 comprises a feedstation frame 16 connected to the rear part 4 of the main frame 2 and a bulk material feeder, in this case a vibrating feeder 17, connected to the feedstation frame, the vibrating feeder 17 having a rearward feed end 18 to receive bulk material from e.g., an excavator and a frontward discharge end 19 that overlaps the bulk material inlet 6 of the jaw crusher 5.

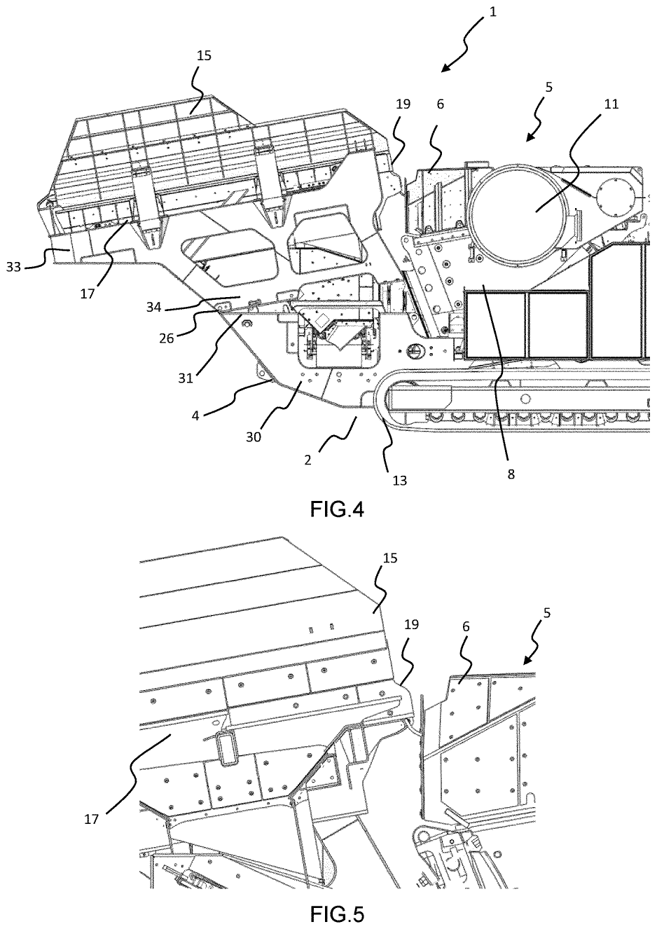

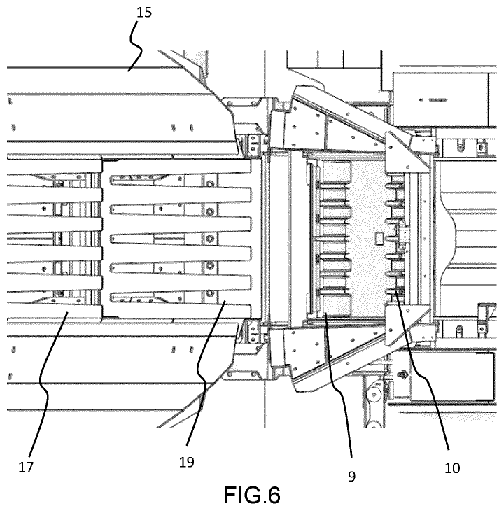

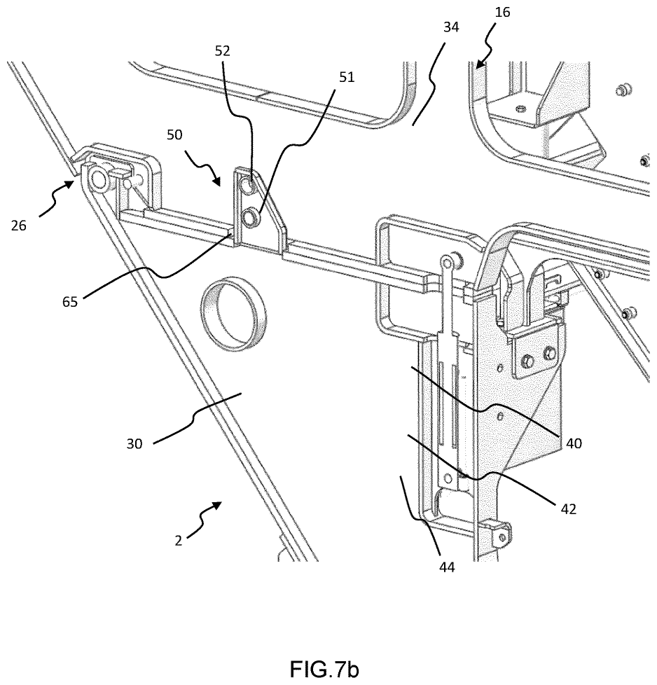

A rearward end 25 of the feedstation frame 16 is pivotably connected to the rear part 4 of the main frame 2 by means of a pivot joint 26. This arrangement allows for pivotable actuation of the feedstation frame 16 in an arc from an operating position illustrated in FIGS. 1 to 3 in which the discharge end 19 of the vibrating feeder 17 overlaps the bulk material inlet 6 of the jaw crusher 5 to a non-operating position illustrated in FIGS. 4 to 6 in which the in which the discharge end 19 of the vibrating feeder 17 is disposed rearwardly of the crushing chamber inlet 6. This is best illustrated in the plan views from above of FIGS. 3 and 6 that illustrate how the feedstation is moved so that it no longer overlaps the crusher inlet, thus allowing vertical clearance above the crusher from the crusher to be lifted away from the apparatus. As mentioned above, this may be performed when the weight of the apparatus has to be reduced to allow it to be legally transported on the roads, or when access is required to difficult to access parts of the apparatus such as jaw wedge bolts, rubber seals, chute liners and the underscreen mesh.

The rear part 4 of the main frame 2 comprises spaced apart sidewall sections 30 having an upper surface 31. The feedstation frame 16 comprises an upper beam 33 and a shorter lower beam 34 and connecting beams 35. The vibrating feeder 17 is mounted across the upper beams 33 for vibrational movement to move bulk material along the feeder from the rearward feed end 16 to the discharge end 19 where it falls into the inlet of the crusher when the feedstation is in the operating position shown in FIGS. 1 to 3. The lower beam 34 is pivotably coupled to the upper surface 31 of each sidewall section 30 of the main frame 2 at the pivot joints 26. When in the operating position shown in FIGS. 1 to 3, the lower beam 34 is supported on the upper surface 31 of the main frame sidewall sections 30.

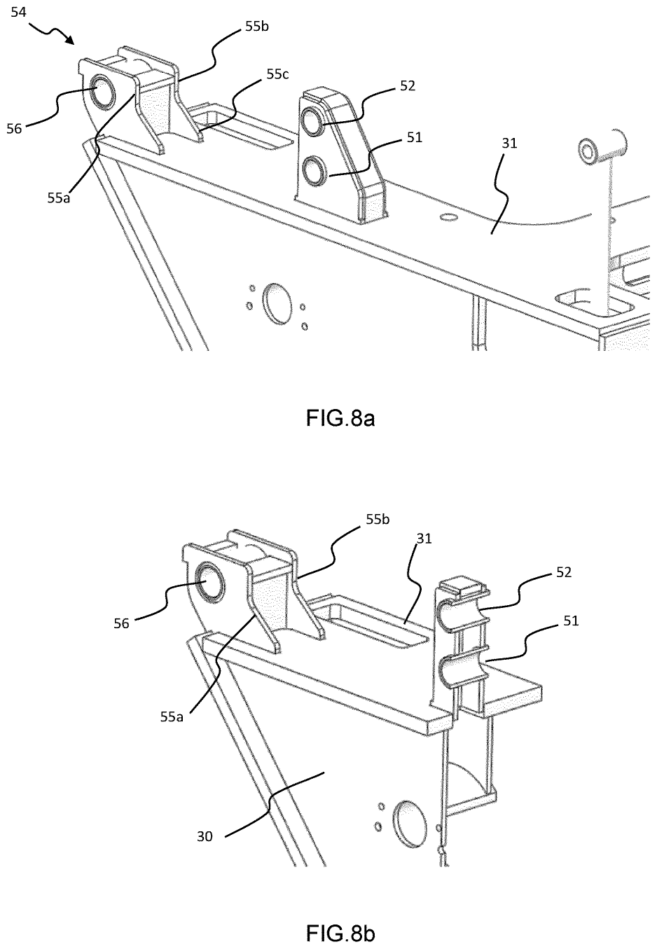

Referring to FIGS. 7a and 7b, which are partly sectional views, the apparatus 1 includes a pivot actuator module mounted between the main frame 2 and the feedstation frame 16 to controllably pivot the feedstation frame in an arc between the operating position and non-operating position. The pivot actuation module comprises a hydraulic ram 40 mounted at an upper end 41 to the lower beam 34 and a lower end 42 to the sidewall section 30 of the main frame 2. The apparatus has hydraulic rams 40 on each side of the main frame to pivot the feedstation between the operating and non-operating positions shown in FIGS. 7b and 7a, respectively. Referring to FIG. 7a, each hydraulic ram is mounted within a ram housing 44. In use, the feedstation frame is generally horizontal when it is resting on the main frame and is disposed at an angle of about 20° to the supporting surface 31of the main frame 2 when it is pivoted by the pivot actuation module into the non-operating position. This angle may vary depending on the type of bulk material primary processing that forms part of the apparatus.

As shown in FIG. 7a, the sidewalls 60 also comprise through apertures 65 that align with the cylindrical pivot pin housing 56 allowing a pivot pin 57 to be passed through the apertures to pivotably couple the feedstation frame to the main frame.

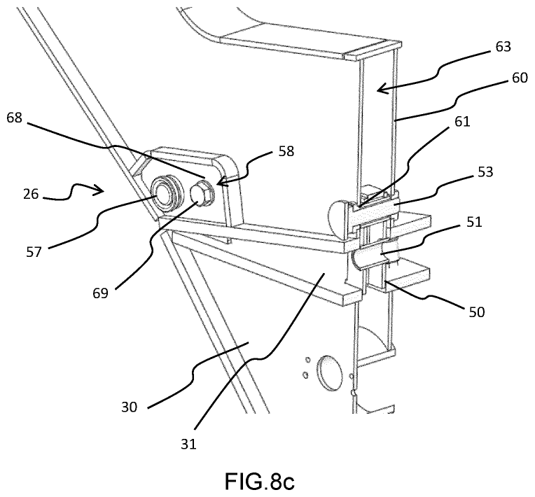

FIG. 8a to 8c illustrate the pivot joint and locking module to lock the feedstation frame in a pivoted non-operating position (as shown in FIG. 8c).

Referring initially to FIGS. 8a and 8b, there is illustrated a top surface 31 of one sidewall section 30 of the main frame. A locking arm 50 extends upwardly from the top surface 31 and has two main frame locking apertures 51 and 52. A first part 54 of the pivot joint 26 is mounted to the upper surface 31 and comprises spaced apart flange sections 55a and 55b supporting a cylindrical pivot pin housing 56, each flange having a slanted section 55c that extends forwardly and downwardly away from the through aperture.

Referring to FIG. 8c, which shows the feedstation frame pivoted into the non-operating position, the lower beam 34 of the feedstation frame 16 comprises spaced apart side walls 60 providing a recess 63 dimensioned to receive the locking arm 50 and having locking apertures 61 configured to align with either of the locking apertures 51 or 52 depending on the angle of the feedstation when it is in the non-operating position. In FIG. 8c, the feedstation is pivoted to a position in which the locking apertures 61 of the lower beam 34 align with the upper locking apertures 52 of the locking arm 50. A locking pin 53 is threaded through the apertures to lock the feedstation frame in the pivoted non-operating position. Additional locking apertures 68 are provided on the lower beam sidewalls 60 adjacent the pivot pin 57. A second locking pin 69 is inserted into the apertures 68 when the feedstation is pivoted into the desired non-operating position, where it is supported by the respective slanted sections 55c of the flange sections 55a and 55b.

In use, when the apparatus has to be transported, the crusher may be removed. This involves pivotably actuating the feedstation frame in an arc from the operating position in which the discharge end of the conveyor overlaps the bulk material inlet of the primary processing unit to a non-operating position in which the discharge end of the conveyor is disposed rearwardly and upwardly of the crushing chamber. The crusher is then uncoupled from the main frame and raised with a crane away from the main frame. The apparatus without the crusher may then be transported separately from the crusher.

In an alternative use, the feedstation may be pivoted into the non-operating position to allow access to difficult to access parts of the apparatus, for example jaw wedge bolts, rubber seals, chute liners and the underscreen mesh.

### Equivalents

The foregoing description details presently preferred embodiments of the present invention. Numerous modifications and variations in practice thereof are expected to occur to those skilled in the art upon consideration of these descriptions. Those modifications and variations are intended to be encompassed within the claims appended hereto.

1. A mobile bulk material processing apparatus comprising:
a main frame having a front part and a rear part;
a bulk material primary processing unit detachably attached to the front part of the main frame and including a bulk material inlet; and
a feedstation arranged to feed bulk material to the primary processing unit, the feedstation including a feedstation frame connected to the rear part of the main frame and a bulk material feeder connected to the feedstation frame, the bulk material feeder having a rearward feed end arranged to receive bulk material and a frontward discharge end that overlaps the bulk material inlet (6) of the primary processing unit, wherein a rearward end of the feedstation frame is pivotably connected to the main frame for pivotable actuation of the feedstation frame in an arc from an operating position in which the discharge end of the bulk material feeder overlaps the bulk material inlet of the primary processing unit to a non-operating position in which the discharge end of the bulk material feeder is disposed rearwardly of the bulk material inlet to allow the primary processing unit to be vertically lifted away from the main frame.

2. The mobile bulk material processing apparatus according to claim 1, wherein the primary processing unit is a bulk material crusher having a crushing chamber.

3. The mobile bulk material processing apparatus according to claim 1, comprising a pivot actuator module mounted between the main frame and the feedstation frame to controllably pivot the feedstation frame in an arc between the operating position and non-operating position.

4. The mobile bulk material processing apparatus according to claim 3, wherein the pivot actuator module includes a fluidic ram disposed on each side of the apparatus, each hydraulic ram being coupled at one end to the main frame and at the other end to the feedstation frame.

5. The mobile bulk material processing apparatus according to claim 3, wherein the pivot actuator module is configured to pivot the feedstation frame to a non-operating position that is disposed at an angle Θ of 10° to 30° to the operating position.

6. The mobile bulk material processing apparatus according to claim 1, wherein the feedstation frame is disposed substantially horizontally when in the operating position.

7. The mobile bulk material processing apparatus according to claim 1, wherein the apparatus includes a locking module to lock the feedstation frame in a pivoted non-operating position.

8. The mobile bulk material processing apparatus according to claim 7, wherein the locking module is configured to lock the feedstation frame in a plurality of non-operating positions.

9. The mobile bulk material processing apparatus according to claim 7, wherein the locking module includes a main frame locking aperture in the main frame, a feedstation frame locking aperture in the feedstation frame positioned to overlap the mainframe locking aperture in the main frame when the feedstation is in a non-operating position, and a locking pin configured to pass through the locking apertures to lock the feedstation frame in a pivoted position relative to the main frame.

10. The mobile bulk material processing apparatus according to claim 9, wherein main frame includes a first main frame locking aperture and a second main frame locking aperture disposed above the first main frame locking aperture configured to lock the feedstation frame in either of two non-operating positions.

11. The mobile bulk material processing apparatus according to claim 9, wherein the main fame locking aperture is provided on an upstanding locking arm and wherein the feedstation frame includes a recess configured to receive the locking arm.

12. The mobile bulk material processing apparatus according to claim 1, wherein the rearward end of the feedstation frame is pivotably connected to the main frame by a pivot joint including a first pivot joint part disposed on the main frame including a cylindrical pivot pin housing a second pivot joint part including apertures on the feedstation frame that align with the cylindrical pivot pin housing, and a pivot pin.

13. The mobile bulk material processing apparatus according to claim 12, wherein the first pivot joint part disposed on the main frame includes a pair of spaced apart flange sections supporting the cylindrical pivot pin housing each having a slanted section that extends forwardly and downwardly away from the pivot pin housing, wherein the second pivot joint part includes locking apertures disposed forwardly of the cylindrical pivot pin housing to receive a second locking pin when the feedstation is pivoted into the non-operating position.

14. A method of operating a mobile bulk material processing apparatus, comprising the steps of:
providing a mobile bulk material processing apparatus according to claim 1; and
pivotably actuating the feedstation frame in an arc from the operating position in which the discharge end of the conveyor overlaps the bulk material inlet of the primary processing unit to a non-operating position in which the discharge end of the conveyor is disposed rearwardly and upwardly of the crushing chamber inlet to allow the primary processing unit to be vertically lifted away from the main frame.

15. The method according to claim 14, further comprising uncoupling the primary processing unit from the main frame and lifting the primary processing unit upwardly away from the main frame.

16. The method according to claim 14, further comprising performing maintenance on difficult to access parts of the apparatus that are accessible as a result of the pivotable actuation of the feedstation frame into the non-operating position.

17. The method according to claim 14, wherein the mobile bulk material processing apparatus includes a pivot actuator module, and wherein the step of pivotably actuating the feedstation frame in an arc from the operating position to the non-operating position includes actuation of the pivot actuator module.

18. The method according to claim 14, wherein the primary processing unit is a crusher chamber.

19. The method according to claim 18, wherein the primary processing unit is a jaw crusher chamber.
